(19) United States
(12) Patent Application Publication
(10) Pub. No.: US 2007/0056215 A1
(43) Pub. Date: Mar. 15, 2007

(54) Automatic device for watering cultivated plants

(76) Inventor: Roland Weninger, Telfs (AT)

Correspondence Address: Thomas M. Saunders;Brown Rudnick Berlack Israels LLP, Pne Financial Center, Box IP, Boston, MA, 02111, US

(21) Appl. No.: 11/515,123

(22) Filed: Sep. 1, 2006

(30) Foreign Application Priority Data
Sep. 12, 2005 (AT) A 1489/2005

(51) Int. Cl. A01G 25/00

(52) U.S. Cl. 47/79

(57) ABSTRACT

An automatic device for watering cultivated plants comprising a liquid distributor which can be inserted into the earth (8) surrounding the plants and a supply container connected thereto by a substantially tube-form or hose-form conduit, wherein the wall (1) of the liquid distributor has porous openings only in its part surrounded by the earth (8), with a pressure-dependent shut-off member which is disposed between the tube-form or hose-form conduit and the liquid distributor.

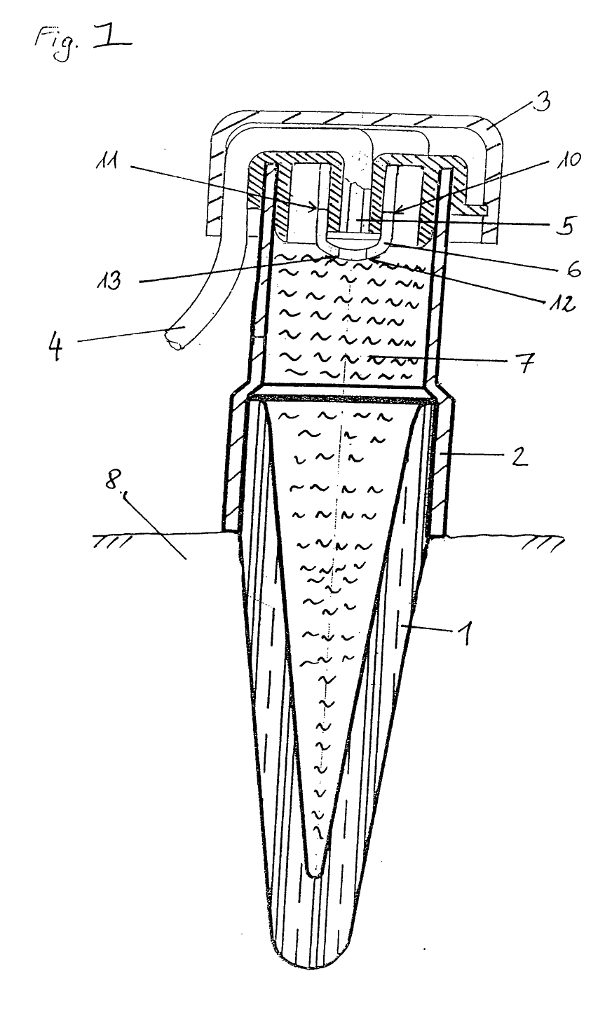

### FIELD OF THE INVENTION

The invention concerns an automatic device for watering cultivated plants comprising a liquid distributor which can be inserted into the earth surrounding the plants and a supply container connected thereto by a substantially tube-form or hose-form conduit, wherein the wall of the liquid distributor has porous openings only in its part surrounded by the earth.

### BACKGROUND OF THE INVENTION

Devices of the general kind set forth are known for example from DE 15 82 761. The purpose of such devices is to deliver given amounts of water over prolonged periods of time to a volume which is filled with earth, without requiring supervision or actuation, insofar as, with the aid of capillary forces, they afford an equilibrium between the amount of water which is delivered to the earth and the amount of water which flows out of the supply container into the liquid distributor. The moisture content which is to be set in the earth is to be freely predeterminable in accordance with the requirements of the plant. Maintaining a selected moisture content requires the supply of liquid to the earth to be controlled by the conditions in the earth itself. A constant feed flow of water is not adequate for that purpose. The device of the general kind set forth as described in DE 15 82 761 is wherein the level of liquid in the supply container is below the level of liquid in the liquid distributor which is in the form of a closed hollow body and that the liquid distributor has air-permeable wall regions only in its part surrounded by earth, wherein the air-permeable wall regions only have porous openings. A disadvantage with the state of the art is the fact that, when the water supply container is set up above the level of liquid in the liquid distributor liquid continuously flows into the liquid distributor and is discharged to the earth by way of the pores of the liquid distributor. The plants are thereby exposed to an excessively large amount of water. One approach for preventing that effect provides that the porosity of the part of the liquid distributor which is surrounded by the earth is reduced, but that in turn can have the result that the amount of water delivered to the earth is not sufficient for the plants.

Therefore the object of the invention is to provide a device with which the plant is not excessively greatly watered even if the level of liquid of the supply container lies above the liquid distributor.

### SUMMARY OF THE INVENTION

According to the invention that is attained by a pressure-dependent shut-off member which is disposed between the tube-form or hose-form conduit and the liquid distributor. By virtue of the introduction of such a shut-off member, in particular such a shut-off member which is so designed that it delivers water from the supply container into the liquid distributor as soon as liquid has been delivered from the liquid distributor to the earth which is outside the distributor, it is possible to establish an equilibrium in which there is only ever as much water introduced into the liquid distributor from the water supply, as was delivered to the earth from the liquid distributor.

A possible embodiment of such a device provides that the shut-off member is a valve. In particular pressure valves which open at a given pressure difference could be used in that respect. The valves would be in the form of through-way valves and it would also be possible to use for example simple safety valves.

A particularly preferred embodiment provides that the shut-off member includes a diaphragm (or membrane) which has at least one self-sealing through opening. In the simplest case the diaphragm could be a rubber or plastic material which is fitted in place and which at certain locations has so-called self-sealing through openings, wherein they can be achieved for example by simply perforating the diaphragm. The material properties of the rubber or plastic material ensure that such through openings which are inserted by perforation close automatically and form a water-tight wall up to a certain pressure. Those self-sealing through openings open as from a given pressure difference between the two sides upstream and downstream of the through opening and permit liquid (or gas) to pass through. It is preferably provided that the shut-off member is regulatable in dependence on pressure. The delivery of water from the liquid distributor to the surrounding earth produces a certain reduced pressure in the liquid distributor and the pressure difference upstream and downstream of the diaphragm increases, so that fluid can flow out of the water supply container into the liquid distributor. A preferred embodiment provides that the self-sealing through openings are so designed that they are water-impervious up to a hydrostatic pressure of between 20 cm and 100 cm water column. Expressed in other terms the self-sealing through openings are so designed that they are water-impervious at a hydrostatic pressure of about 50 cm water column.

So that such a device can be operated the liquid distributor is filled, air-tightly closed and connected to a conduit leading to the supply container. As soon as liquid passes outwardly through the porous walls of the liquid distributor a reduced pressure occurs in the interior thereof, which, when that reduced pressure has reached a certain level, leads to transport of liquid out of the liquid container. Ideally an equilibrium is reached between the liquid distributor and the surrounding earth by the prevailing capillary forces and the reduced pressure which is produced in the liquid distributor (steady-stale). Then the same amount of liquid passes into and out of the hollow body as is consumed or evaporated by the cultivated plants and from the surface of the earth respectively.

In the state of the art, the liquid which passes into the earth in the equilibrium state is established primarily by virtue of the difference in level between the level of liquid in the supply container and the lowest point in the liquid distributor (at least when the system is filled with water), that the liquid reaches on its way into the liquid distributor. If that difference is great, a considerable reduced pressure is required in the liquid distributor to overcome that difference, and that reduced pressure in turn can be produced only by a capillary action as occurs only with a relatively low level of moisture. However the state of the art has the disadvantage that, with an excessively great difference in level, that is to say when the liquid supply container is disposed excessively high in relation to the liquid distributor, that equilibrium is disturbed. Consequently too much liquid passes into the liquid distributor and thereupon also into the earth. The shut-off members according to the invention, in particular in the form with the pressure-dependent, self-sealing through openings, avoid that disadvantage in a simple but outstanding fashion. It is then possible for the liquid supply container also to be mounted at higher positions. Handling is markedly facilitated thereby for the user has greater independence in terms of choosing the positioning of the supply container and can also mount it above the level of the liquid distributor.

It is further provided that the wall of the liquid distributor at least portion-wise comprises clay or similar porous material, in the region which can be inserted into the earth. It is further provided that the liquid container when inserted into the earth has an air-impermeable wall in that region which projects out of the earth. In proper use of the device, an air-impermeable upper wall, that is to say a wall which projects out of the earth, is required insofar as pressure equalisation between the supply container and the liquid distributor is not to be achieved by the entrance of air but by water flowing through the shut-off member.

A further embodiment provides that the liquid distributor is of a substantially transparent nature at least in region-wise manner. A transparent region, for example in the upper region which projects out of the earth, makes it possible to clearly recognise whether there is a sufficient amount of water in the liquid distributor.

In order to connect the device to the conduit in such a way as to be resistant to tensile forces and nonetheless to be able to transpose it inexpensively, it has proven to be advantageous if the conduit which is in tube or hose form and which leads to the liquid distributor is fixed in a plug or a cap which closes off the liquid distributor. A preferred variant provides that the conduit in tube or hose form is introduced into the cap or the plug from the side of the cap or the plug which is towards the liquid distributor. Such a configuration is visually more attractive and in particular has the advantage that no bore has to be provided in the plug or the cap at the top side. Ideally it is also provided that the pressure-dependent shut-off member is fitted in the cap or the plug as in such a configuration the conduit does not have to be cut up for the purposes of fitting the shut-off member therein.

### BRIEF DESCRIPTION OF THE DRAWING

Further advantages and details of the invention will be described with reference to the FIGURE and the specific description.

The FIGURE diagrammatically shows a device according to the invention (without water supply container) inserted into the earth, in cross-section.

### DETAILED DESCRIPTION

In the embodiment illustrated in the FIGURE the porous part 1 of the liquid distributor is shown in the form of a hollow cone of clay. The slender shape which converges downwardly to a tip facilitates insertion into the earth 8 so that the device can be easily planted at any time. In the region which projects out of the earth 8 the device has a sleeve 2 which on the one hand makes the part that projects out of the earth air-impermeable while on the other hand the fact that the sleeve 2 is in the form of a translucent plastic material means that it is possible to see at any time whether there is a sufficient amount of water 7 present in the liquid distributor. Fitted on to the sleeve 2 is a cap 3 into which extends a hose 4 which leads to the water supply container (not shown). The hose 4 is guided into a water inlet opening 5 which also comprises plastic material. Fitted around the water inlet opening 5 is a separating diaphragm 6 which substantially comprises a rubber or a rubber-like material. Provided in the separating diaphragm 6 are a plurality of through openings 10, 11, 12, 13 both laterally on the diaphragm and also at the underside of the diaphragm, with self-sealing properties. They open automatically at a given pressure difference and allow water to pass into the interior 7 of the liquid distributor. If the pressure difference from the supply container and in the interior 7 of the liquid distributor is reduced to a given value (for example 100 cm water column), those pores or self-sealing through openings 10, 11, 12, 13 close automatically and it is only after water has been delivered to the earth 8 through the porous part 1 of the hollow cone that water then again flows out of the supply container.

It will be appreciated that the invention is not limited to the embodiment illustrated. It would certainly be conceivable for the shape and configuration, in particular of the liquid distributor, to be different. For example the circular or honeycomb structure as is also used in the known state of the art (see DE 15 82 761) would also be conceivable in this case. Such devices can be designed with very long feed flow conduits 4 so that the liquid distributor can be arranged at a long distance from the supply container. In addition a plurality of liquid distributors can be mounted to a supply container.

1. An automatic device for watering cultivated plants comprising a liquid distributor which can be inserted into the earth surrounding the plants and a supply container connected thereto by a substantially tube-form or hose-form conduit, wherein the wall of the liquid distributor has porous openings only in its part surrounded by the earth, characterised by a pressure-dependent shut-off member which is disposed between the tube-form or hose-form conduit and the liquid distributor.

2. A device according to claim 1 wherein the shut-off member is a valve.

3. A device according to claim 1 wherein the shut-off member includes a diaphragm which has at least one self-sealing through opening.

4. A device according to claim 3 wherein the self-sealing through openings are so designed that they are water-impervious up to a hydrostatic pressure of between 20 cm and 100 cm water column.

5. A device according to claim 3 wherein the self-sealing through openings are so designed that they are water-impervious at a hydrostatic pressure of about 50 cm water column.

6. A device according to claim 1 wherein the liquid distributor is of a substantially transparent nature at least in region-wise manner.

7. A device according to claim 1 wherein the conduit which is in tube or hose form and which leads to the liquid distributor is fixed in a plug or a cap which closes off the liquid distributor.

8. A device according to claim 7 wherein the conduit in tube or hose form is introduced into the cap or the plug from the side of the cap or the plug which is towards the liquid distributor.

9. A device according to claim 7 wherein the pressure-dependent shut-off member is fitted in the cap or the plug.
